(19) United States
(12) Patent Application Publication
(10) Pub. No.: US 2009/0279068 A1
(43) Pub. Date: Nov. 12, 2009

(54) Device and process for increasing the light transmission of optical elements for light having a wavelength close to the absorption edge

(76) Inventors: Martin Letz, Mainz (DE); Lutz Parthier, Kleinmachnow (DE)

Correspondence Address: STRIKER, STRIKER & STENBY, 103 EAST NECK ROAD, HUNTINGTON, NY, 11743, US

(21) Appl. No.: 12/436,878

(22) Filed: May 7, 2009

(30) Foreign Application Priority Data
May 10, 2008 (DE) 10 2008 023 238.6

(51) Int. Cl. G03B 27/52

(52) U.S. Cl. 355/77

(57) ABSTRACT

Described are a process and a device for increasing the light transmission of an optical element for light of a wavelength that is close to the absorption edge of the material constituting the optical element. The process involves cooling the optical element. The process is especially well suited for microlithography with immersion objectives. A preferred device is, for example, a stepper for producing electronic components.

The invention relates to a process for increasing the transmission of an optical element for light having a wavelength close to the absorption edge, to a device therefor and to the use thereof for producing electronic components.

Electronic components are usually made with the aid of photolithography. This involves exposing a photosensitive coating to light by use of a circuit-image forming mask, removing the exposed or unexposed regions of the coating and then appropriately continuing the processing. The requirements placed on such components, for example computer chips, are constantly increasing. As a result, the structures or circuit elements are becoming smaller and smaller and must be disposed more and more closely to each other. For a long time it was sufficient to illuminate such electronic components with the light from a mercury lamp, for example light having a wavelength of 365 nm (l-line) or with a KfF excimer laser at 248 nm. In modern illumination equipment, known as steppers, ArF excimer lasers with a wavelength of 193 nm are currently used. In this manner it is possible, by means of common illumination optical system consisting of quartz or calcium fluoride, to form circuit elements having a width of less than 100 nm. By use of special techniques it is possible to produce at such wavelengths even narrower structures having, for example, a width of 95 nm. To create even narrower structures, for example of 40 nm, the immersion technique known from light microscopy is currently commonly used. To this end, the air or vacuum between the object to be illuminated and the last optical element of the illumination optical system is replaced with a liquid having as high a refractive index as possible. When an ArF laser is used with an immersion optical system made of CaF₂ and with deionized water as the immersion liquid, it is possible, at least theoretically, to achieve a resolution of (193 nm/2)×1.44 =67 nm. The maximum numerical aperture is, of course, also limited by the refractive index of the lens material when this index is smaller than that of the immersion liquid used. Whereas for light with a wavelength of 193 nm quartz glass has a refractive index (n₁₉₃) of 1.56, CaF₂ which because of its favorable transmission properties is preferred has a refractive index n₁₉₃=1.50 and BaF₂ has a refractive index n₁₉₃=1.58. On the other hand, immersion liquids are available which have a refractive index of up to 1.70. This higher resolution or imaging accuracy brought about by immersion can be further increased if the last optical element of the illumination system coming in contact with the immersion liquid, which usually is the front lens of the projection assembly, also has a high refractive index.

Such highly refractive materials suitable for a front lens, particularly for immersion lithography, are described, for example, in DE 10 2005 024 682 A1. According to this publication, it is possible readily to incorporate into the crystal lattice alkaline earth metal fluorides by doping with divalent metal ions having an ionic radius similar to that of the alkaline earth metal ion. Moreover, the refractive index of alkaline earth metal fluorides can be increased by incorporation of monovalent and trivalent metal ions in a stoichiometric ratio of 1:1 when these ions are selected so that the sum of the third power of the ionic radius of the monovalent ion and the third power of the ionic radius of the trivalent ion equal the sum of the third powers of the ionic radii of two alkaline earth metal ions. In this manner it is possible to obtain alkaline earth metal fluorides which at a wavelength of 193 nm have a refractive index greater than 1.5.

It is known from EP 1 701 179 A1 to use cubic garnets, cubic spinels or cubic perovskites and cubic M(II) oxides as well as M(IV) oxides for the creation of optical elements for UV radiation. Typical crystals are Y₃Al₅O₁₂, Lu₃Al₅O₁₂, Ca₃Al₂Si₃O₁₂, K₂NaAlF₆, Ka₂NaScF₆, K₂LiAlF₆, and/or Na₃Al₂Li₃F₁₂ (Mg,Zn)Al₂O₄, CaAl₂O₄, CaB₂O₄ and/or LiAl₅O₈ as well as BaZrO₃ and/or CaCeO₃.

Moreover, J. Burnett et al. described in “Proceedings of the SPIE”, vol. 5754, No. 1 (May 2005) various materials as “high-index materials”, for example MgO, CaO, SrO and BaO as well as the mixed oxides of these substances. The use of sapphire as front lens for immersion lithography is also described therein.

Such materials are suitable as front lenses for immersion optical systems particularly for a wavelength below 200 nm.

Such materials, however, present an absorption edge which is already close to the working wavelength of 193 nm so that their absorption is no longer negligible.

The invention therefore has for an object to provide a process and a device that overcome the afore-described drawbacks and that show improved light transmission, particularly in the region of the front lens, preferably in immersion lithography.

This objective is reached by means of the features defined in the claims.

According to the invention, we have, in fact, found that for wavelengths close to the absorption edge, namely for wavelengths for which the optical material becomes nontransparent to light, light transmission can be appreciably increased if the optical element is cooled. According to the invention, for microlithography this effect is particularly well suited especially at wavelengths below 250 nm and preferably at wavelengths below 200 nm.

Within the framework of the invention, by absorption edge is meant the wave range in which the material constituting the optical element irradiated by the wavelength no longer allows light to pass. The procedure of the invention is particularly well suited for wavelengths which have a distance of less than about 80 nm and particularly less than 70 nm from the wavelength or from the position of the absorption edge, and the light energy of which amounts to less than 2.3 and particularly less than 2 eV compared to that of the absorption edge. The procedure of the invention was found to be especially well suited for wavelengths and materials for which the distance of the working wavelength from the position of the absorption edge amounts to less than 1.5 eV or 1 eV and preferably less than 0.7 or 0.5 eV. Most preferably the distance of the wavelength used from the absorption edge amounts to a maximum of 0.3 eV and particularly to a maximum of 0.2 eV.

According to the invention, preferred as optical elements are materials with a refractive index greater than 1.5 and particularly greater than 1.55, a refractive index greater than 1.6 or 1.62 being particularly preferred. Most preferred are materials with a refractive index greater than or equal to 1.65 or even 1.68.

Such materials are, in particular, cubic garnets, cubic spinels, cubic perovskites and cubic M(II) and M(IV) oxides. Suitable crystals are Y₃Al₅O₁₂, Lu₃Al₅O₁₂, Ca₃Al₂Si₃O₁₂, K₂NaAlF₆, Ka₂NaScF₆, K₂LiAlF₆, and/or Na₃Al₂Li₃F₁₂ (Mg,Zn)Al₂O₄, CaAl₂O₄, CaB₂O₄ and/or LiAl₅O₈ and BaZrO₃ and/or CaCeO₃ consisting of cubic garnets having the general formula

(A₁₋ₓDₓ)₃Al₅)₁₂

wherein D is an element similar to A³⁺ in terms of valency and ionic radius so as to keep the lattice distortions as small as possible. According to the invention, preferred elements A are, in particular, yttrium, the rare earths or lanthanides, namely Ce, Pr, Nd, Pm, Sm, Eu, Gd, Tb, Dy, Ho, Er, Tm, Yb and/or Lu as well as scandium, the elements Y, Lu, Yb, Tm, Dy and Sc being particularly preferred. Suitable representatives of the doping agent D are also selected from the group comprising yttrium, the rare earths and scandium. Particularly well suited have been found to be the garnets of the Y₃Al₅O₁₂, Lu₃Al₅O₁₂, Dy₃Al₅O₁₂, Tm₃Al₅O₁₂ and Yb₃Al₅O₁₂ type and, in particular, a mixed crystal of (Y₁₋ₓLuₓ)Al₅O₁₂, doped with other rare earths and/or Sc.

Here x denotes the mole fraction 0≦x≦1 with A and D preferably being different.

In another well suited optical material consisting of an alkaline earth metal fluoride, the crystal is doped with monovalent and trivalent ions in a stoichiometric ratio of 1:1, with the monovalent and trivalent ions being selected so that the sum of the square of the radius of the monovalent ion and the square of the radius of the trivalent ion is so similar to the sum of the squares of the radii of two alkaline earth metal ions that pairs of monovalent and trivalent ions can be incorporated into the crystal lattice of the alkaline earth metal fluoride.

In a particularly preferred manner, the divalent metal ions to be incorporated into a CaF₂ crystal lattice have a radius between 80 and 120 pm. Such ions can be, for example, Cd²⁺, Sr²⁺, Hg²⁺, Sn²⁺, Zn²⁺ and/or Pb²⁺. All these ions have a radius similar to that of Ca²⁺ so that they can be incorporated into the crystal lattice of CaF₂. Whereas Ca²⁺ has a radius of 100 pm, Cd²⁺ has a radius of 95 pm, Sr²⁺ a radius of 118 pm, Hg²⁺ one of 102 pm, Sn²⁺ one of 118 pm and Pb²⁺ a radius of 119 pm. The use of Cd²⁺, Hg²⁺, Sn²⁺ and/or Pb²⁺ is particularly preferred.

A similar situation applies to material consisting of BaF₂. Because Ba²⁺ has an ionic radius of 143 pm, here the doping can be done with divalent metal ions with a radius between 110 and 170 pm namely so similar to that of Ba²⁺ that the ions can be incorporated into the crystal lattice of BaF₂.

In a preferred arrangement, the monovalent metal ion is Na⁺ and the trivalent metal ion is La³⁺, Bi³⁺, Y³⁺, Tm³⁺, Yb³⁺, Lu³⁺ and/or Tl³⁺. In an equally preferred manner, the monovalent metal ion can be Ag⁺ and the trivalent metal ion is Y³⁺, Ir³⁺, In³⁺, Sb³⁺ and/or Tl³⁺. Moreover, the monovalent metal ion can be K⁺ and/or Au⁺ and the trivalent ion Al³⁺.

In a preferred embodiment, the optical element is cooled to an extent of at least 5° C., cooling to an extent of at least 10° C. relative to the normal working temperature being particularly preferred. A typical working temperature is, for example, room temperature which, however, can be increased by storing radiation energy in the optical element. According to the invention, however, a temperature reduction to the extent of at least 20 or 25° C. is particularly advantageous. A temperature reduction of at least 30° C. and particularly of at least 40° C. or even at least 50° C. has been found to be most preferred.

The cooling itself can be brought about by means of common techniques known to those skilled in the art, for example by rinsing with a cooling fluid, the fluid possibly being either gaseous or liquid. Typical gaseous fluids are, for example, air, nitrogen or helium. The gas is preferably dried. Suitable liquid fluids are, for example, water or organic liquids, for example an oil. An immersion liquid may also be used as cooling fluid if the optical element involved is the front lens of an immersion optical system. Another suitable cooling element is, for example, a Peltier element. In addition, laser cooling has been found suitable for the optical element cooling of the invention. In this case, the element is irradiated by laser light. As the laser light passes through the element, the radiation is absorbed by the doping agents present in the lens material and then given off in the form of energy-enriched radiation. In this manner, the entire element is cooled.

The invention also relates to a device for carrying out the process of the invention. Such a device comprises, in particular, an optical element, preferably an image-forming optical system, and an arrangement for cooling at least one optical element, particularly for microlithography. The optical element itself consists of a material with a band edge that is close to the working wavelength and which irradiates the optical element. The required radiation is possibly produced by a radiation source present in the device or is introduced from the outside. Typical radiation sources are, for example, a KrF excimer laser or an ArF excimer laser. The device of the invention preferably comprises an optical system for high-energy illumination, involving, in particular, a wavelength below 250 nm or 200 nm. Typically, the device is adapted for illumination of materials, particularly those provided with a photosensitive coating, for example for computer chip production, and comprises the components that are required for this purpose.

Optical systems suitable for this purpose are the projection optical systems. In a particularly preferred embodiment, the front element or front lens is cooled in the device of the invention. The cooled front lens is preferably part of an immersion optical system.

Thus, the device comprises a system for cooling of the optical element or elements. The cooling arrangement itself comprises, in particular, also the afore-described cooling techniques. Hence, it is provided with a feed pipe and an outlet for the cooling medium that removes energy from the optical element. The cooling medium can be a gaseous or liquid fluid or an electromagnetic cooling wave. The cooled fluids remove heat by contact with the optical element, whereas the electromagnetic wave while passing through the optical element picks up energy from said element and then exits as an energy-enriched radiation. Typical fluids are, for example, air, nitrogen or helium, and typical electromagnetic cooling is, for example, laser cooling. Another cooling element is, for example, a Peltier element. Naturally, sufficient cooling can be brought about by other suitable arrangements known to those skilled in the art. A typical device according to the invention is, for example, a stepper for microlithography.

Hence, the invention also relates to the use of the device of the invention or of the process of the invention for lenses, prisms, light-conducting rods, optical windows and optical components for DUV photolithography, steppers and excimer lasers and for the production of electronic components, computer chips and integrated circuits as well as electronic devices containing such circuits and chips.

The invention will now be explained more closely with the aid of the following example:

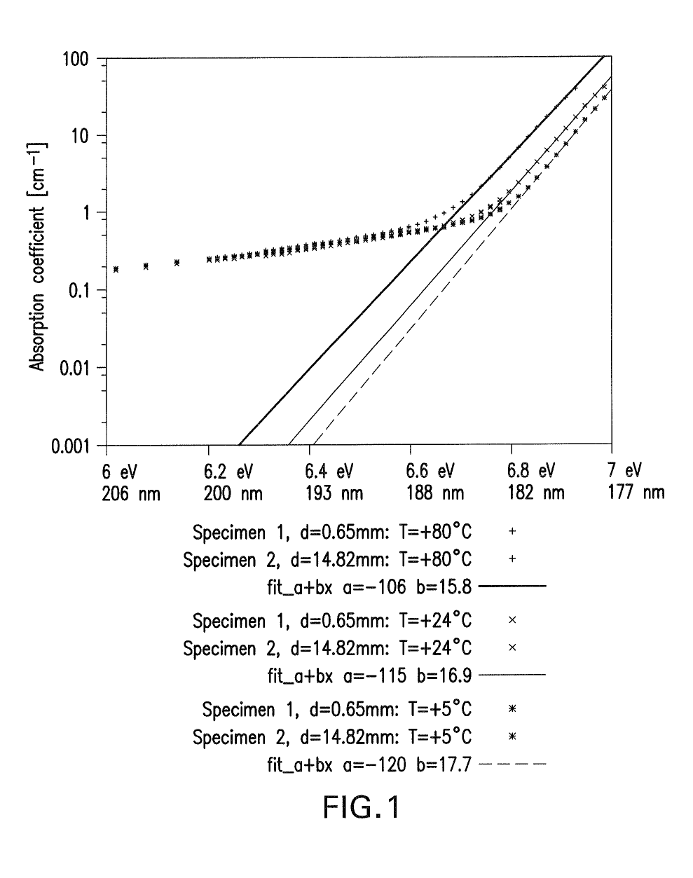

FIG. 1 shows a logarithmic plot of the absorption coefficient for wavelengths of the light, expressed in eV, whereby the absorption by a highly purified lutetium-aluminum garnet crystal (LuAG) was determined. LuAg has, for example, an absorption edge at about 170 nm or at a wavelength of 7 eV. The absorption was measured on two different highly-purified LuAG specimens by use of a radiation passage of 0.65 mm (specimen 1) and 14.82 mm (specimen 2) at a wavelength between 206 and 177 nm and from this measurement the extinction coefficient based on 1 cm was determined. By carrying out the measurement on specimens of different thickness, it is possible to determine the pure absorption without distortions by surface absorption. In this manner, the absorption coefficients were determined for the wavelengths between 206 and 177 nm at +5° C. (*), at 24° C. (×) and at 80° C. (+). As can be seen from the plot, above 178-190 nm the cooling brought about a definite reduction in absorption which at a wavelength of 183 nm still clearly increased. We found that at room temperature and at a working wavelength of 194 nm cooling a LuAG crystal by 10° C. reduced the absorption from 0.0060 cm⁻¹ to 0.0039 cm⁻¹, namely by a factor of 0.64. If cooling is extended by +5° C., an absorption of only 0.0026 cm⁻¹ is achieved, namely the absorption amounts to only 43% of that noted at room temperature. Further cooling to an extent of 10, 20, 30 or even 50° C. brings about further reduction.

1. Process for increasing the ability of an optical element to transmit light of a wavelength that is close to the absorption edge of the material constituting the optical element, characterized in that the optical element is cooled.

2. Process according to claim 1, characterized in that the light has a wavelength that is at the most 2 eV above the absorption edge.

3. Process according to claim 1, characterized in that the optical element is cooled to an extent of at least 5° C.

4. Process according to claim 1, characterized in that the optical element consists of a highly ionic dielectric.

5. Process according to claim 1, characterized in that a photo-sensitive coating is illuminated with the cooled optical element to produce electronic components.

6. Process according to claim 1, characterized in that the optical element consists of an alkaline earth metal fluoride that is doped with divalent metal ions, the divalent metal ions being selected so that they have an ionic radius that is so close to the ionic radius of the alkaline earth metal ion that the divalent metal ions can be incurporated into the crystal lattice of the alkaline earth metal fluoride, or that the optical element consist of an alkaline earth metal fluoride that is doped with monovalent and trivalent ions in a stoichiometric ratio of 1:1, the monovalent and trivalent ions being selected so that the sum of the third power of the ionic radius of the monovalent ion and the third power of the ionic radius of the trivalent ion is so close to the sum of the third powers of the ionic radii of two alkaline earth metal ions that pairs of monovalent and trivalent ions can be incorporated into the crystal lattice of the alkaline earth metal fluoride.

7. Process according to claim 1, characterized in that the material is a cubic garnet, cubic spinel, cubic perovskite or cubic M(II) or M(IV) oxide.

8. Process according to claim 1, characterized in that the materi-al is Y₃Al₅O₁₂, Lu₃Al₅O₁₂, Ca₃Al₂Si₃O₁₂, K₂NaAlF₆, Ka₂NaScF₆, K₂LiAlF₆, and/or Na₃Al₂Li₃F₁₂ (Mg,Zn)Al₂O₄, CaAl₂O₄, CaB₂O₄ and/or LiAl₅O₈ as well as BaZrO₃ and/or CaCeO₃.

9. Process according to claim 1, characterized in that at 193 nm the material constituting the optical element has a refractive index greater than 1.5.

10. Device with optical elements showing an increased light transmission for wavelengths that are close to the absorption edge of its irradiated optical elements, characterized in that it comprises a cooling system that cools at least the last optical element.

11. Device according to claim 10, characterized in that the device is a lithography stepper, particularly for DUV immersion lithography.

12. Device according to claim 10, characterized in that the cooling device com-prises a Peltier element, a cooling fluid and/or a laser cooling element.

13. Device according to claim 10, characterized in that the optical element is made of an alkaline earth metal fluoride, particularly of CaF₂ or spinel or LuAG.

14. Use of the process according to claim 1 or of the device for lenses, prisms, light-conducting rods, optical windows, excimer la-sers and optical components for DUV photolithography as well as for the production of electronic components, steppers, computer chips and integrated circuits and of electronic devices containing such circuits and chips.
